(19) United States
(12) Patent Application Publication
(10) Pub. No.: US 2026/0011269 A1
(43) Pub. Date: Jan. 8, 2026

(54) CABLE LABELING

(71) Applicant: Sound Strap LLC, Englewood, CO (US)

(72) Inventor: Daniel Carlson, Englewood, CO (US)

(21) Appl. No.: 19/230,359

(22) Filed: Jun. 6, 2025

Related U.S. Application Data
(60) Provisional application No. 63/666,799, filed on Jul. 2, 2024.

(51) Int. Cl. G09F 3/20; F16L 3/233

(52) U.S. Cl. CPC G09F 3/205; F16L 3/233

(57) ABSTRACT

A bundling kit includes a plurality of straps and a plurality of labels. Each strap is configured for wrapping around a plurality of lengths of elongate flexible members. The straps each include a head having an opening, a tail extending from the head in a first direction and a tab extending from the head in a second direction at a link spacing the tab from the head. The tail is configured for insertion through the opening. Front and back surface of the tail are configured to adhere to one another and front and back surfaces of the head. Each of the labels is configured to adhere to any of the tabs.

### CROSS-REFERENCE TO RELATED APPLICATIONS

The disclosure claims the benefit of and incorporates herein by reference in its entirety, U.S. Provisional Application No. 63/666,799 filed 2 Jul. 2024 and entitled ‘CABLE LABELING’, pending.

### SUMMARY

The disclosure describes a bundling kit. The bundling kit includes a plurality of straps and a plurality of labels. Each strap is configured for wrapping around a plurality of lengths of elongate flexible members. The straps each include a head having an opening, a tail extending from the head in a first direction and a tab extending from the head in a second direction at a link spacing the tab from the head. The tail is configured for insertion through the opening. Front and back surface of the tail are configured to adhere to one another and front and back surfaces of the head. Each of the labels is configured to adhere to any of the tabs.

The disclosure also describes a labeling kit. The labeling kit includes a plurality of straps and a plurality of labels. The straps each include a head, a tail extending from the head in a first direction and a tab extending from the head in a second direction. The tail is configured for selectively maintaining a looped configuration at any of a variety of circumferences. The labels are each configured to selectively couple with any of the tabs.

Further, the disclosure describes a bundling strap. The bundling strap includes a head, a tail extending from the head in a first direction and a tab extending from the head in a second direction. The head has a front surface, a back surface and an opening therethrough. The tail has a front surface and a back surface and is configured for selectively maintaining a looped configuration at any of any of a variety of diameters/circumferences and for insertion through the opening. The tab has a front surface and a back surface.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates an example wrapping, bundling or labeling kit.

FIG. 2 illustrates a first side of an example strap of a first variety suitable for use in association with the example kit of FIG. 1.

FIG. 3 illustrates a second side of the example strap of FIG. 2.

FIG. 4 illustrates a first side of an example strap of a second variety suitable for use in association with the example kit of FIG. 1.

FIG. 5 illustrates a second side of the example strap of FIG. 4.

FIG. 6 illustrates a first side of an example strap of a third variety suitable for use in association with the example kit of FIG. 1.

FIG. 7 illustrates a second side of the example strap of FIG. 6.

FIG. 8 illustrates a first side of an example strap of a fourth variety suitable for use in association with the example kit of FIG. 1.

FIG. 9 illustrates a second side of the example strap of FIG. 8.

FIG. 10 illustrates first sides of several labels suitable for use in association with the example straps of FIGS. 2-9 and/or the kit of FIG. 1.

FIG. 11 illustrates second sides of the example labels of FIG. 10.

FIG. 12 illustrates an example strap wrapped around a cable and inserted through a portion of itself with an example label selectively attached thereto.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity but rather denote the presence of at least one of the referenced item.

Many modern networking, A/V, and power applications require numerous cables of different types and functions. These cables are often difficult to distinguish from one another quickly and easily. Some solutions exist to this issue, but they are either temporary and require frequent replacement, or rely on time-consuming and failure-prone solutions including handwritten notes. Further, loose and/or unbound cables can get tangled and may present a hazard.

Embodiments of the disclosure provide a wrapping, bundling and/or labeling kits and associated methods.

Embodiments of the disclosure substantially eliminate, or at least partially address, problems in the prior art, enabling quick coupling of labels to cables and other elongate flexible members with a high degree of visibility while also enabling organizing or maintaining coils of cable in a more manageable arrangement.

Additional aspects, advantages, features and objects of the disclosure will be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

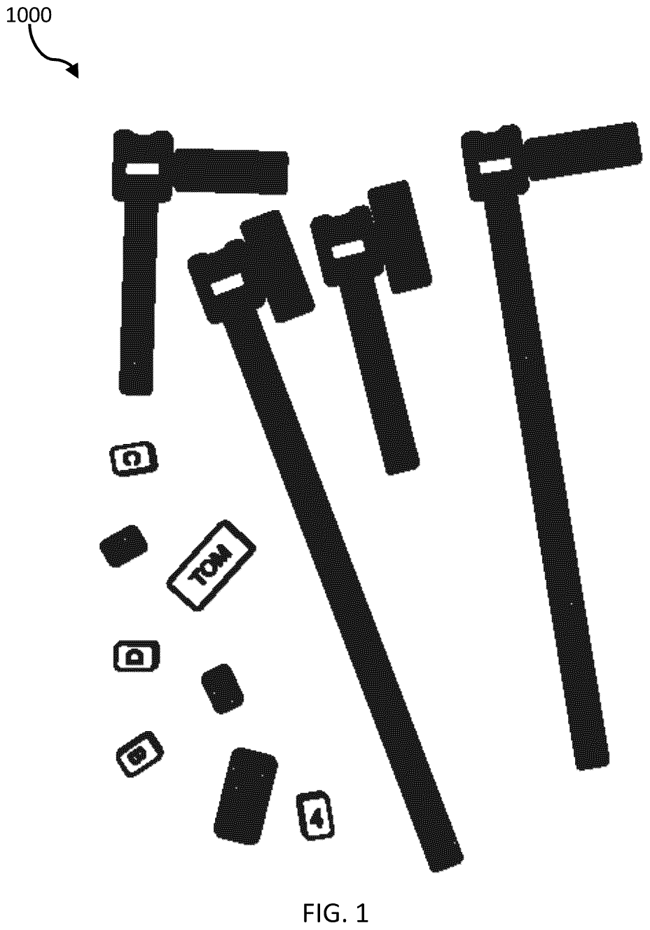

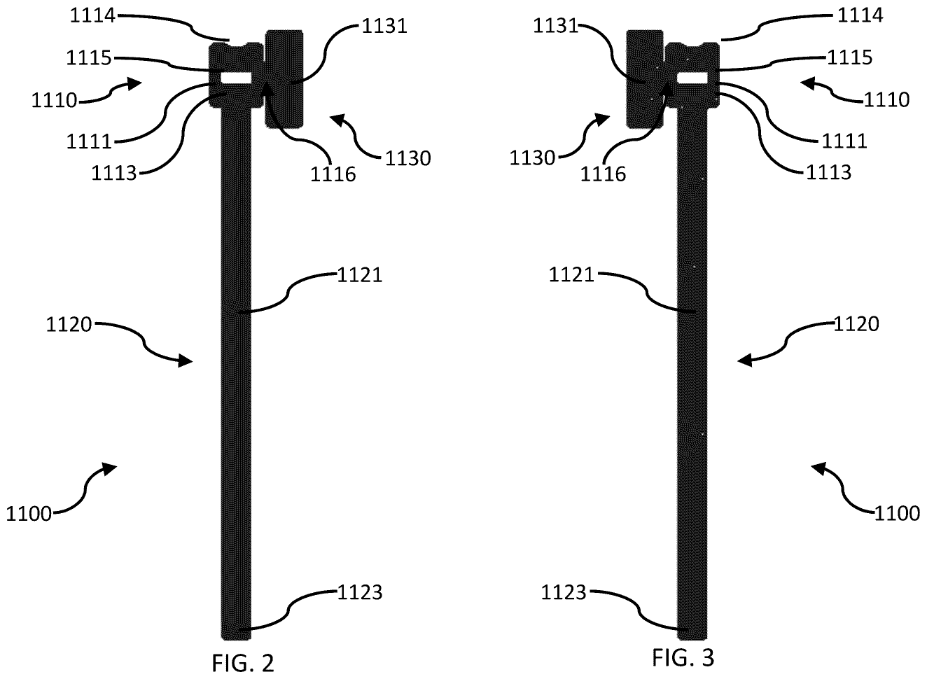

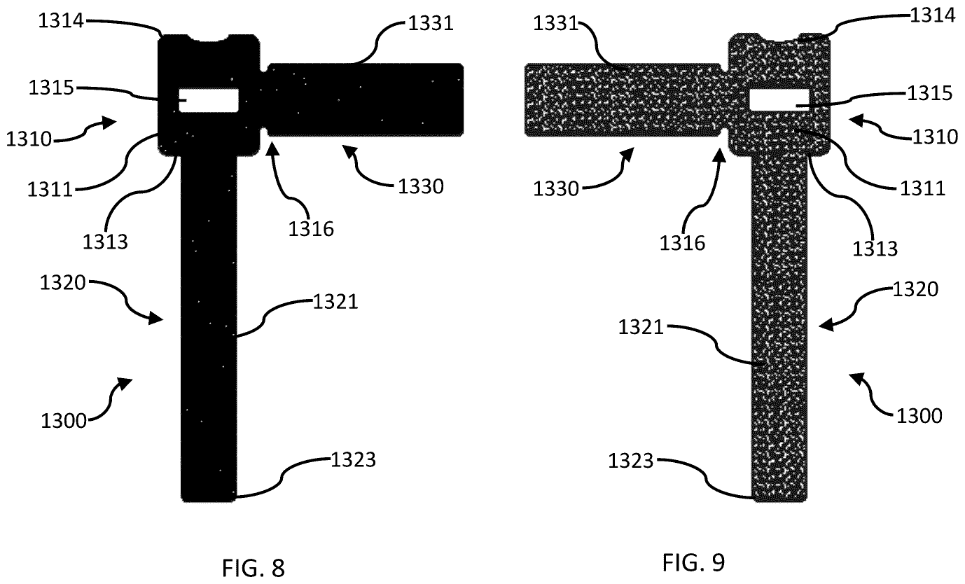

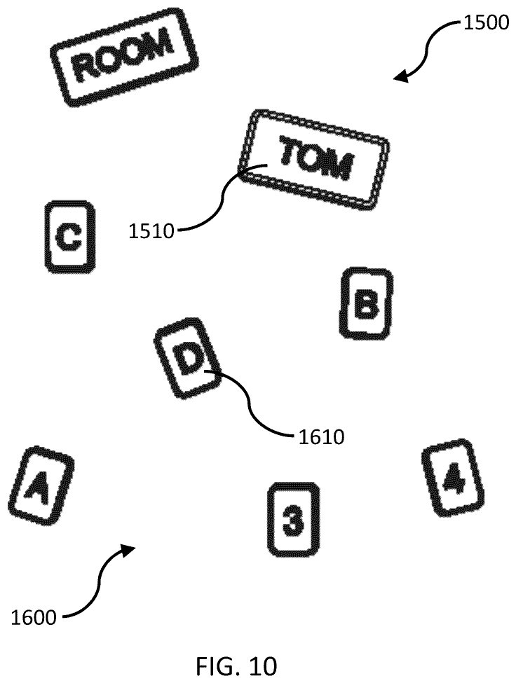

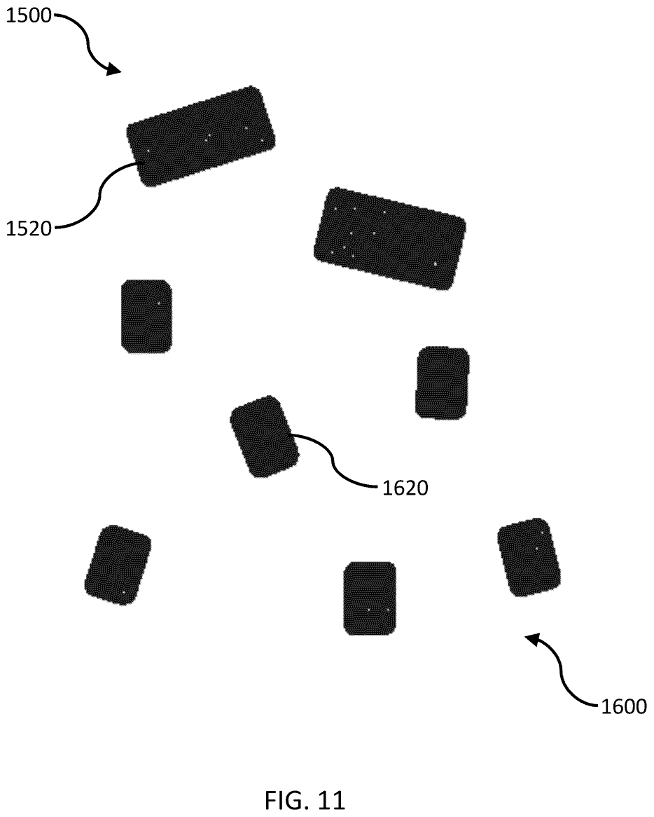

FIGS. 1-11 illustrate example elements or components of a wrapping, bundling or labeling kit 1000. Kit 1000 includes a plurality of wraps, strips or straps 1100, 1200, 1300 and 1400 (FIGS. 2-9) and a plurality of labels 1500 and 1600 (FIGS. 10 & 11). Each strap 1100, 1200, 1300, 1400 is configured for wrapping around and/or bundling one or more objects such as a plurality of lengths of elongate flexible member or members including but not limited to a coiled cable. Each strap 1100, 1200, 1300, 1400 includes a head 1110, 1210, 1310, 1410 and a tail 1120, 1220, 1320, 1420 extending from the head in a first direction.

Each head 1110, 1210, 1310, 1410 may have a back surface 1112, 1212, 1312, 1412, a front surface 1111, 1211, 1311, 1411, a first transverse dimension or width, a base 1113, 1213, 1313, 1413, a crown 1114, 1214, 1314, 1414 with a concavity defined between two corners and a mouth or opening 1115, 1215, 1315, 1415 through the front and back surfaces intermediate the base and the crown. Each opening 1115, 1215, 1315, 1415 may have a second transverse dimension or width less than the first width. The concave edge of each crown 1114, 1214, 1314, 1414 may provide facilitated gripping when applying and removing from a flexible elongate member as well as facilitated manipulation of strap 1100, 1200, 1300 and/or 1400.

Each tail 1120, 1220, 1320, 1420 is configured for insertion through the respective opening 1115, 1215, 1315, 1415 and for selectively maintaining a looped configuration at any of a variety of circumferences. Each tail 1120, 1220, 1320, 1420 may have a respective back surface 1122, 1222, 1322, 1422 a respective front surface 1121, 1221, 1321, 1421 a third transverse dimension suitable for fitting within the second transverse dimension and a longitudinal dimension between the respective head 1110, 1210, 1310, 1410 and a distal end 1123, 1223, 1323, 1423.

An ear or tab 1130, 1230, 1330, 1430 extends from head 1110, 1210, 1310, 1410, respectively, in a second direction at a small, notched connecting strip or link 1116, 1216 1316 1416 spacing the respective tab 1130, 1230, 1330, 1430 from the respective head 1110, 1210, 1310, 1410. The second direction may be generally transverse to the first direction. Stated differently, each tab 1130, 1230, 1330, 1430 may extend from a side of the respective head 1110, 1210, 1310, 1410 while each tail 1120, 1220, 1320, 1420 extends from a bottom or base 1113, 1213, 1313, 1413 of the respective head 1110, 1210, 1310, 1410.

Each tab 1130, 1230, 1330, 1430 may have a respective back surface 1132, 1232, 1332, 1432, a respective front surface 1131, 1231, 1331, 1431, a second longitudinal dimension and a fourth transverse dimension. Having tabs 1130, 1230, 1330, 1430 extend from the side of the respective heads 1110, 1210, 1310, 1410, generally in a direction transverse to the direction of the respective tail 1120, 1220, 1320, 1420, facilitates manipulation of the tab when wrapping around one or more elongate flexible members. Each link 1116, 1216, 1316, 1416 reduces the degree to which the respective tab 1130, 1230, 1330, 1430 portion flexes when applied. This may allow for a more stable connection between the tabs and labels 1500, 1600.

Each label 1500, 1600 is configured to adhere to or otherwise couple to/with any of tabs 1130, 1230, 1330, 1430. Each also has a back surface 1520, 1620 and a front surface 1510, 1610 bearing indicia 1511, 1611.

Back surfaces 1112, 1212, 1312, 1412 of each head and the front surfaces 1121, 1221, 1321, 1421 of the respective tails are configured to cooperatively adhere to one another and subsequently non-destructively separate from one another after an indefinite duration. Front surfaces 1111, 1211, 1311, 1411 of each head and the back surfaces 1122, 1222, 1322, 1422 of the respective tails are configured to cooperatively adhere to one another and subsequently non-destructively separate from one another after an indefinite duration. Front surfaces 1121, 1221, 1321, 1421 and back surfaces 1122, 1222, 1322, 1422 of the respective tails 1120, 1220, 1320, 1420 are configured to cooperatively adhere to one another and non-destructively separate from one another after an indefinite duration.

Back surfaces 1520, 1620 of the labels and front surfaces 1131, 1231, 1331, 1431 of the tabs are configured to cooperatively adhere to one another and non-destructively separate from one another after an indefinite duration. Thus, components of the disclosed kits are suitable for wrapping, bundling and/or labeling repeatedly without loss of effectiveness and/or adherence.

Front surfaces of heads 1110, 1210, 1310, 1410, tails 1120, 1220, 1320, 1420 and tabs 1130, 1230, 1330, 1430 may include a first component of a fastening mechanism while back surfaces of heads 1110, 1210, 1310, 1410, tails 1120, 1220, 1320, 1420 and tabs 1130, 1230, 1330, 1430 include a second component of a fastening mechanism. Back surfaces 1520, 1620 of labels 1500, 1600 may include a second component of a fastening mechanism. Alternatively, back surfaces 1520, 1620 of labels 1500, 1600 may include a third component of a fastening mechanism configured for coupling with one or both of the first and second components of the fastening mechanism.

For example, front surfaces 1111, 1211, 1311, 1411 of the heads, front surfaces 1121, 1221, 1321, 1421 of the tails and front surfaces 1131, 1231, 1331, 1431 of the tabs may include a first component of hook-and-loop fastener and back surfaces 1122, 1222, 1322, 1422 of the tails, back surfaces 1112, 1212, 1312, 1412 of the heads and back surfaces 1132, 1232, 1332, 1432 of the tabs may include a second component of hook-and-loop fastener. In a further example, front surfaces 1111, 1211, 1311, 1411 of the heads, front surfaces 1121, 1221, 1321, 1421 of the tails and front surfaces 1131, 1231, 1331, 1431 of the tabs may include a loop fastener and back surfaces 1122, 1222, 1322, 1422 of the tails, back surfaces 1112, 1212, 1312, 1412 of the heads and back surfaces 1132, 1232, 1332, 1432 of the tabs may include a hook fastener.

For example, back surfaces 1520, 1620 of labels 1500, 1600 may include a second component of a hook-and-loop fastener. In a further example, back surfaces 1520, 1620 may include a hook fastener.

Features of the straps 1100, 1200, 1300 and 1400 may take any of a variety of dimensions suitable for enabling functions including but not limited to wrapping tails 1120, 1220, 1320, 1420 around wires or cabling, inserting tails 1120 through openings 1115, 1215, 1315, 1415 and applying visible labels 1500, 1600 to tabs 1130, 1230, 1330, 1430.

The width of heads 1110, 1210, 1310, 1410 may be about one-and-a-half times the transverse dimension or width of the respective tail 1120, 1220, 1320, 1420. For example, the width of each head 1110, 1210, 1310, 1410 may be about 0.750 inches. In an example, a longitudinal dimension or length of each head 1110, 1210, 1310, 1410 may be about 0.875 inches.

The tail of one or more of the straps may have a first length while the tail of one or more of the straps has a second length different from the first length. In accordance with a first variety of strap (FIGS. 2-5), the longitudinal dimension or length of each tail 1120, 1220 may be about eight times the longitudinal dimension or length of the respective head 1110, 1210 and about five to about five-and-a-half times the longitudinal dimension or length of the respective tab 1130, 1230. For example, the longitudinal dimension or length of each tail 1120, 1220 may be about 7.000 inches. The transverse dimension or width of each tail 1120, 1220 may be about 0.500 inches.

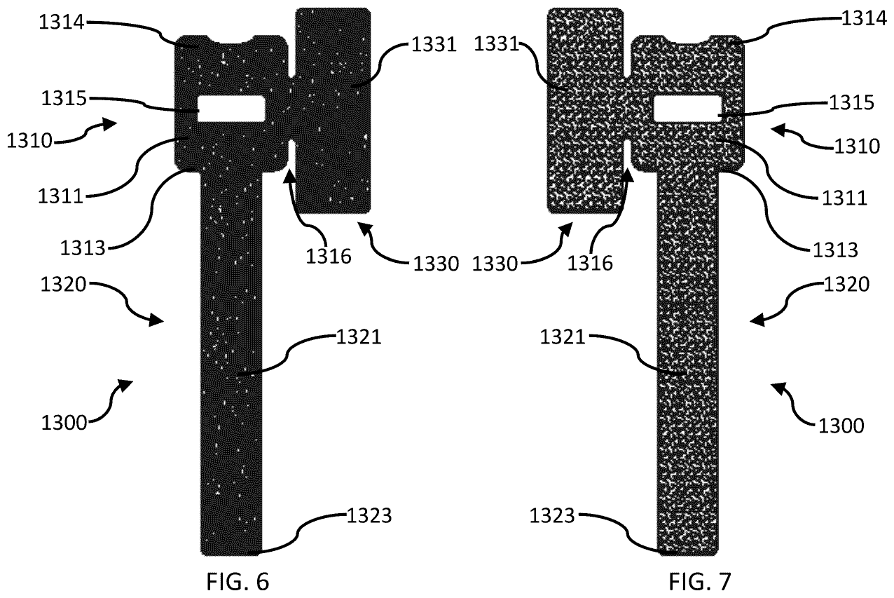

In accordance with a second variety of strap (FIGS. 6-9), the longitudinal dimension or length of each tail 1320, 1420 may be about two-and-a-half to about three times the longitudinal dimension or length of the respective head 1310, 1410 and about one-and-a-half to about two times the longitudinal dimension or length of the respective tab 1330, 1430. For example, the longitudinal dimension or length of each tail 1320, 1420 may be about 2.500 inches. The transverse dimension or width of each tail 1320, 1420 may be about 0.500 inches.

The tab 1230, 1430 of one or more of straps 1200 and 1400 may have a length extending transverse to the respective tail 1220, 1420 while the tab 1130, 1330 of one or more of straps 1100 and 1300 has a length extending parallel to the respective tail 1120, 1320. Any number of varieties or types of straps may be provided as part of kit 1000.

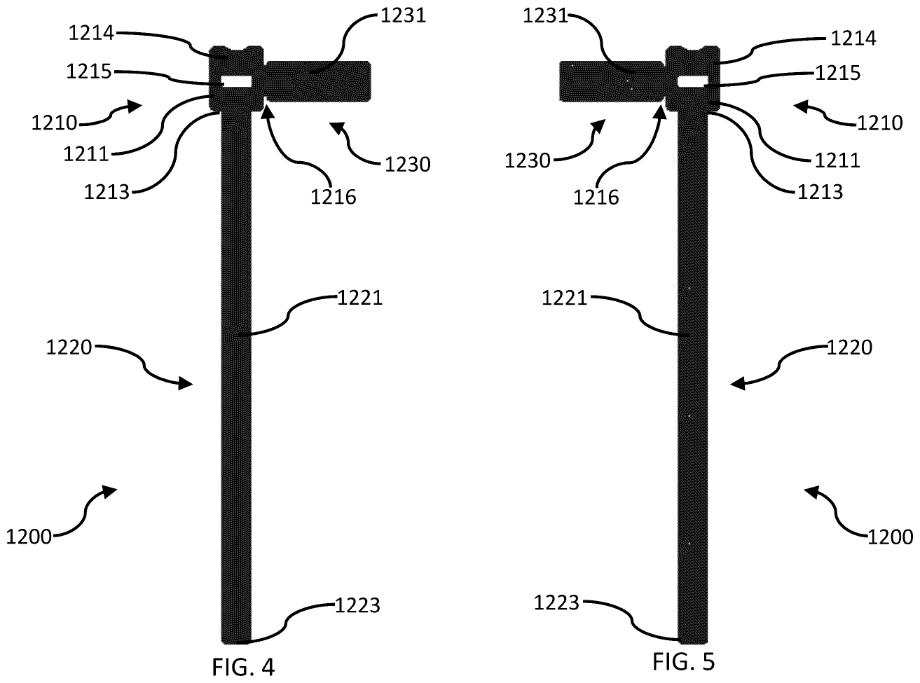

The transverse dimension or width of each tab 1130, 1230, 1330, 1430 may be approximately equal to the transverse dimension or width of the respective tail 1120, 1220, 1320, 1420. For example, the transverse dimension or width of each tab 1130, 1230, 1330, 1430 may be about 0.500 inches. In an example, the longitudinal dimension or length of each tab 1130, 1230, 1330, 1430 may be about 1.375 inches. When the length of each tab 1130, 1230, 1330, 1430 is oriented transversely (FIGS. 4, 5, 8 & 9), the transverse dimension or width of each tab 1130, 1230, 1330, 1430 may be about 1.375 inches while the longitudinal dimension or length is about 0.500 inches. Each link 1116, 1216, 1316, 1416 may have a length less than a width of the respective tab 1130, 1230, 1330, 1430. For example, each link 1116, 1216, 1316, 1416 may be about 0.375 inches long and have a width of about 0.063 inches or may otherwise space the respective tab 1130, 1230, 1330, 1430 from the respective head 1110, 1210, 1310, 1410 by about 0.063 inches.

Kit 1000 may include any number of label varieties or types. For example, one or more labels 1500 may have indicia 1521 of a first type while one or more labels 1600 have indicia 1621 of a second type different from the first. In a further example, the indicia 1521 and/or 1621 includes a variety of characters which may be letters, numbers symbols or combinations of these. In another example, one or more labels 1500 may have a first length while one or more labels 1600 have a second length different from the first length.

While generally described in a kit configuration, individual components of kit 1000 may be offered separately or in different groupings from those specifically described.

Straps 1100, 1200, 1300, 1400 may be comprised of any of a variety of materials configured for looping and/or coiling and/or wrapping. In an example, straps 1100, 1200, 1300, 1400 may include a flexible material. In a further example, straps 1100, 1200, 1300, 1400 may include a fabric. In a still further example, straps 1100, 1200, 1300, 1400 are cut from a sheet of material having a first locking mechanism on one side and a second locking mechanism on the opposite side. Labels 1500, 1600 may be comprised of any of a variety of durable materials including but not limited to rubber. In an example, one or more luminescent materials may be included in or with straps 1100, 1200, 1300, 1400 and/or labels 1500, 1600.

Disclosed wrapping, bundling and/or labeling kits and components thereof may be suitable for use in association with any of a variety of wrapping, bundling and/or labeling methods.

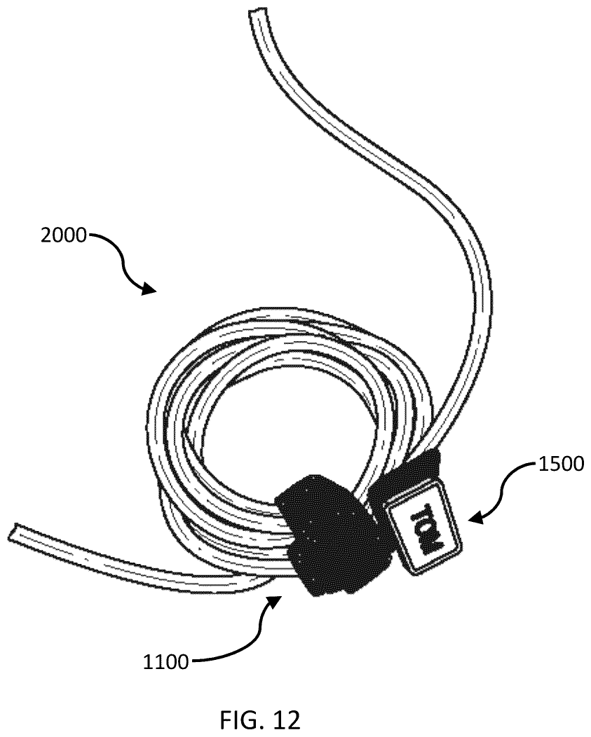

An example labeling method includes at least partially wrapping a strap tail around an exterior of at least one elongate flexible member 2000 with a strap head adjacent to the exterior of the elongate flexible member and inserting a distal end of the tail through an opening in the strap head until the strap tail encompasses the elongate flexible member as closely as desired. Depending upon the length of the tail and the diameter of the elongate flexible member, the strap may wrap completely around or may wrap around multiple times. Then, a back surface of the tail is pressed against a front surface of the tail and a front surface of a base of the strap head to cause an adherence, a back surface of the strap head near a crown is pressed against the front surface of the tail to cause an adherence and a back surface of a label is pressed against a front surface of a tab extending from a side of the strap head to cause an adherence. FIG. 12 illustrates an example strap wrapped around a cable and inserted through itself with an example label selectively attached thereto.

An example bundling method includes at least partially wrapping a strap tail around a plurality of elongate flexible members with a strap head adjacent to exterior surfaces of the elongate flexible members and inserting a distal end of the tail through an opening through the strap head until the strap tail encompasses the elongate flexible members as closely as desired. Depending upon the length of the tail, the diameter of the elongate flexible members and the number of flexible members, the strap may wrap completely around the bundler or may wrap around the bundle multiple times. Then, a back surface of the tail is pressed against a front surface of the tail and a front surface of a base of the strap head to cause an adherence, a back surface of the strap head near a crown is pressed against the front surface of the tail to cause an adherence and a back surface of a label is pressed against a front surface of a tab extending from a side of the strap head to cause an adherence.

The back surface of the label may be pressed against the front surface of the tab such that an indicia-bearing front surface of the label faces away from the front surface of the tab.

In accordance with an alternative method and/or additional actions, the straps may be wrapped such that the head front surface adheres to the tail back surface, such that head back surface adheres to the tail front surface or such that the head back surface adheres to tail front surface at a head crown and the head front surface adheres to tail back surface at a head base.

Embodiments of the disclosure are susceptible to being used for various purposes, including, though not limited to, enabling users to label, wrap and/or bundle one or more elongate flexible members such as wires, ropes, cables or cords.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A bundling kit, comprising:
a plurality of straps configured for wrapping around a plurality of lengths of elongate flexible members, the straps each including:
a head having an opening;
a tail extending from the head in a first direction and configured for insertion through the opening;
a tab extending from the head in a second direction at a link spacing the tab from the head; and
wherein a front surface of the tail is configured to selectively adhere to a back surface of the tail and a back surface of the head and the back surface of the tail is configured to selectively adhere to a front surface of the head; and
a plurality of labels each configured to selectively adhere to the tab.

2. The bundling kit as set forth in claim 1, wherein the link has a length less than a width of the tab.

3. The bundling kit as set forth in claim 1, wherein the tail of one or more of the straps has a first length and the tail of one or more of the straps has a second length different from the first length.

4. The bundling kit as set forth in claim 1, wherein the tab of one or more of the straps has a length transverse to the tail and the tab of one or more of the straps has a length parallel with the tail.

5. The bundling kit as set forth in claim 1, wherein the labels include one or more labels having indicia of a first type and one or more labels having indicia of a second type different from the first.

6. The bundling kit as set forth in claim 1, wherein the labels include one or more labels having a first length and one or more labels having a second length different from the first length.

7. The bundling kit as set forth in claim 1, wherein front surfaces of the tail, head and tab include a first component of a fastening mechanism.

8. The bundling kit as set forth in claim 7, wherein back surfaces of the tail, head and tab include a second component of a fastening mechanism.

9. The bundling kit as set forth in claim 7, wherein back surfaces of the labels include a second component of a fastening mechanism.

10. A labeling kit, comprising:
a plurality of straps each including:
a head;
a tail extending from the head in a first direction and configured for selectively maintaining a looped configuration at any of a variety of circumferences; and
a tab extending from the head in a second direction; and
a plurality of labels each configured to selectively couple with the tab.

11. The labeling kit as set forth in claim 10, wherein the tab extends from the head at a link spacing the tab from the head.

12. The labeling kit as set forth in claim 10, wherein the tail of one or more of the straps has a first length and the tail of one or more of the straps has a second length different from the first length.

13. The labeling kit as set forth in claim 10, wherein the tab of one or more of the straps has a length transverse to the tail and the tab of one or more of the straps has a length parallel to the tail.

14. The labeling kit as set forth in claim 10, wherein the labels include one or more labels having indicia of a first type and one or more labels having indicia of a second type different from the first.

15. The labeling kit as set forth in claim 10, wherein the labels include one or more labels having a first length and one or more labels having a second length different from the first length.

16. The labeling kit as set forth in claim 10, wherein front surfaces of the tail, head and tab include a first component of a fastening mechanism.

17. The labeling kit as set forth in claim 16, wherein back surfaces of the tail, head and tab include a second component of a fastening mechanism.

18. The labeling kit as set forth in claim 16, wherein back surfaces of the labels include a second component of a fastening mechanism.

19. A bundling strap, comprising:
a head having a front surface, a back surface and an opening therethrough;
configured for selectively maintaining a looped configuration at any of any of a variety of diameters/circumferences and for insertion through the opening, a tail extending from the head in a first direction and having a front surface and a back surface; and
extending from the head in a second direction, a tab having a front surface and a back surface.

20. The bundling strap as set forth in claim 19, further comprising a first component of hook-and-loop fastener provided on the front surfaces of the head, tail and tab and a second component of hook-and-loop fastener provided on the back surfaces of the head, tail and tab.
